(19) United States
(12) Patent Application Publication
(10) Pub. No.: US 2026/0109520 A1
(43) Pub. Date: Apr. 23, 2026

(54) OVENABLE FLEXIBLE PACKAGING STRUCTURES

(71) Applicant: PROAMPAC HOLDINGS INC., Cincinnati, OH (US)

(72) Inventors: Quang T. Phung, Addlestone (GB); Kevin Vyse, London (GB); Vincent Reid, Peterborough (GB)

(21) Appl. No.: 19/414,403

(22) Filed: Dec. 10, 2025

Related U.S. Application Data
(63) Continuation-in-part of application No. 18/369,655, filed on Sep. 18, 2023, now Pat. No. 12,552,139.
(60) Provisional application No. 63/408,021, filed on Sep. 19, 2022.

(51) Int. Cl. B65D 65/40; B65D 81/34

(52) U.S. Cl. CPC B65D 65/40; B65D 81/343; B65D 2203/12; B65D 2565/382

(57) ABSTRACT

A laminated web having a machine direction and a transverse direction extending in a direction perpendicular to the machine direction is provided, and includes outer and inner plies. The outer ply is formed of a paper material having a cutout defining a window region disposed at a predetermined location on the outer ply. The inner ply is formed of a heat sealable, ovenable polymer film having a perforation region disposed at a predetermined location on the inner ply. An adhesive layer is disposed intermediate the outer and inner plies and bonds the outer and inner plies together wherein the outer ply and the inner ply are in registration with each other such that the perforation region is substantially overlapping with the window region. In further aspects, packaging articles, methods for making the laminated web, and method for making the packaging articles are provided.

### CROSS REFERENCE TO RELATED APPLICATION

This application is a continuation-in-part of Ser. No. 18/369,655 filed Sep. 18, 2023, now allowed, which claims the priority benefit of U.S. Provisional Application No. 63/408,021 filed Sep. 19, 2022. Each of the aforementioned applications is incorporated herein by reference in its entirety.

### BACKGROUND

The present disclosure relates generally to flexible product packaging and, in particular, to flexible packaging structures for products such as food products stored and transported for later reheating or cooking.

In one aspect, an ovenable flexible packaging structure comprises a paper layer having a first major surface and a second major surface opposite the first major surface, the paper layer having a cutout defining a window. A printed ink layer is disposed on the first major surface of the paper layer and a varnish layer is disposed over the printed ink layer. A heat sealable polymer layer disposed on the second major surface of the paper layer has a strip of perforations formed therein, wherein the strip of perforations and cutout are at least partially overlapping with each other. An adhesive layer is disposed intermediate the paper layer and the heat sealable polymer layer, the adhesive layer comprising an adhesive for adhesively bonding the paper layer to the heat sealable polymer layer.

In a more limited aspect, the adhesive layer comprises an adhesive free region aligned with the strip of perforations for preventing the adhesive from interfering with the perforations.

In another more limited aspect, the adhesive free region extends in a machine direction of the packaging structure.

In another more limited aspect, the strip of perforations extends in a machine direction of the packaging structure.

In another more limited aspect, the adhesive is one or both of an ovenable adhesive and an adhesive curable with ultraviolet radiation.

In another more limited aspect, the adhesive has a dry coating weight in the range of from 2.5 grams per square meter to 7.5 grams per square meter.

In another more limited aspect, the heat sealable polymer layer comprises a polyethylene terephthalate (PET) based polymer material.

The ovenable flexible packaging structure of claim 1, wherein the heat sealable polymer layer is an ovenable PET material having a seal initiation temperature (SIT) in the range of 80-160 degrees C. when sealed with a sealing pressure of 40 psi and a sealing dwell time of 0.5 seconds.

In another more limited aspect, the heat sealable polymer layer is configured to provide a seal strength in the range of from about 200 g/inch to about 4000 g/inch.

In another more limited aspect, the heat sealable polymer layer has a thickness in the range of from 12-30 microns.

In another more limited aspect, the paper layer comprises a paper having a basis weight in the range of from about 35 gram per square meter (gsm) to about 130 gsm.

In another more limited aspect, one or both of the ink layer and the varnish layer are curable with ultraviolet radiation.

In another more limited aspect, the varnish layer is formed of a heat-resistant varnish.

In a further aspect, a packaging article comprising the ovenable flexible packaging structure in accordance with this disclosure is provided.

In a more limited aspect, the packaging article is selected from the group consisting of a bag and a pouch.

In a further aspect, a method of making an ovenable flexible packaging structure includes presenting a web comprising a paper substrate having a first major surface and a second major surface opposite the first major surface and forming a cutout defining a window in the paper substrate. A printed ink layer is printed on the first major surface of the paper layer and a varnish layer is applied over the printed ink layer. A web comprising a heat sealable polymer film is presented and a strip of perforations is formed in the heat sealable polymer film. A layer of adhesive is applied to one or both of the second major surface of the paper substrate and the heat sealable polymer film. A laminate is formed by bringing the web of heat sealable polymer film into contact with the paper substrate, wherein the strip of perforations and cutout are at least partially overlapping with each other.

In another more limited aspect, the adhesive layer comprises an adhesive free region aligned with the strip of perforations for preventing the adhesive from interfering with the perforations.

In another more limited aspect, a packaging article is formed using the ovenable flexible packaging structure.

In another aspect, a laminated web of material having a machine direction and a transverse direction which extends in a direction perpendicular to the machine direction is provided, the laminated web including an outer ply and an inner ply. The outer ply is formed of a paper material having a cutout defining a window region disposed at a predetermined location on the outer ply. The inner ply is formed of a heat sealable, ovenable polymer film having a perforation region wherein the perforation region is disposed at a predetermined location on the inner ply. An adhesive layer is disposed intermediate the outer ply and the inner ply and bonds the outer ply to the inner ply wherein, in the laminated web, the outer ply and the inner ply are in registration with each other such that the perforation region is substantially overlapping with the window region. In further aspects, packaging articles, and method for making the laminated web and the packaging articles are provided.

In a more limited aspect, the perforation region defines a discrete region that does not form a continuous strip in the machine direction.

In another more limited aspect, the perforation region is bounded entirely within the window region.

In another more limited aspect, the laminated web further comprises one of: the perforation region and the window region are substantially coextensive; and the perforation region is smaller in area than the window region.

In another more limited aspect, the adhesive layer is defined by first and second adhesive strips extending in the machine direction, wherein the first and second adhesive strips are disposed on opposing transverse sides of the window region.

In another more limited aspect, the adhesive layer comprises one or more adhesive free regions wherein adhesive is absent from the adhesive layer, the one or more adhesive free regions being disposed upstream of the window region in the machine direction, downstream of the window region in the machine direction, or both.

In another more limited aspect, the laminated web further comprises a varnish layer disposed on an outward facing surface of the outer ply.

In another more limited aspect, the varnish layer is in registration with the one or more adhesive free regions.

In another more limited aspect, the adhesive layer comprises a first adhesive free region wherein adhesive is absent from the adhesive layer, the first adhesive free region being disposed upstream of the window region in the machine direction and a second adhesive free region wherein adhesive is absent from the adhesive layer, the second adhesive free region being disposed downstream of the window region in the machine direction.

In another more limited aspect, the adhesive layer forms a substantially continuous layer surrounding the window region, and wherein the window region is substantially free of adhesive.

In another more limited aspect, the laminated web further comprises a varnish layer disposed on an outward facing surface of the outer ply.

In another more limited aspect, the laminated web further comprises a printed ink layer disposed between the varnish layer and the outward facing surface of the outer ply.

In another more limited aspect, the printed ink layer comprises an ultraviolet (UV) curable ink.

In another more limited aspect, the varnish layer comprises an ultraviolet (UV) curable, heat-resistant varnish.

In another more limited aspect, the outer ply comprises a paper material selected from the group consisting of a natural kraft paper, a bleached kraft paper, a white kraft paper, a coated paper, a recycled paper, and a grease resistant paper.

In another more limited aspect, the outer ply comprises a paper having a basis weight in the range of from about 35 grams per square meter (gsm) to about 130 gsm.

In another more limited aspect, the inner ply comprises a polymer material configured to provide a sealing initiation temperature (SIT) in the range of from about 80° C. to about 160° C. when sealed under a sealing pressure of 40 psi for a dwell time of 0.5 seconds.

In another more limited aspect, the inner ply comprises a polymer material selected from the group consisting of a heat sealable polyolefin-based polymer material, a heat sealable polyamide-based polymer material, a heat sealable polyester-based polymer material, and a heat sealable regenerated cellulose-based polymer, e.g., a cellophane, material.

In another more limited aspect, the polymer material is selected from the group consisting of low-density polyethylene (LDPE), linear low-density polyethylene (LLDPE), metallocene polyethylene (mPE), cast polypropylene (CPP), copolymers derived from ethylene and propylene, copolymers derived from ethylene, propylene, and one or more additional comonomers, polyethylene-polypropylene blends, polyethylene terephthalate (PET), polybutylene terephthalate (PBT), blends of PET and PBT, biaxially oriented polyethylene terephthalate (BOPET), nylon 6, nylon 6,6, polyamide copolymers, polyamide blends, regenerated cellulose, e.g., cellophane, and regenerated cellulose modified with one or more heat seal promoting additives.

In another more limited aspect, the heat sealable, ovenable polymer film is configured to provide a seal strength in the range of from about 200 g/inch to about 4000 g/inch.

In another more limited aspect, the heat sealable polymer layer has a thickness in the range of from about 12 microns to about 30 microns.

In another more limited aspect, a packaging article formed of the laminated web herein is provided.

In another more limited aspect, the packaging article is selected from the group consisting of a bag and a pouch.

In further aspect, a method of making a laminated web includes providing an outer ply comprising a paper substrate, wherein the outer ply has a first major surface and a second major surface opposite the first major surface. A cutout defining a window is formed in the outer ply. An inner ply is provided which comprises a heat sealable polymer film. The inner ply has a first major surface facing the second major surface of the outer ply and a second major surface opposite the first major surface of the inner ply.

A perforation region is formed on the inner ply, the perforation region comprising a plurality of perforations bounded within the perforation region and an adhesive is plied to one or both of the second major surface of the outer ply and the first major surface of the inner ply. A laminate is formed by bringing the outer ply and the inner ply into contact, wherein, in the laminated web, the outer ply and the inner ply are in registration with each other such that the perforation region is substantially overlapping with the window region.

In a more limited aspect, the method further comprises one or both of forming a printed ink layer disposed on at least a portion of the first major surface of the outer ply and forming a varnish layer disposed on at least a portion of the first major surface of the outer ply.

In another more limited aspect, the method further comprises folding, sealing, and/or manipulating the laminated web to thereby form a packaging article.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is an isometric, fragmentary view of a flexible packaging film in accordance with a first exemplary embodiment of the invention, taken generally from the side intended to face the exterior in a finished packaging article.

FIG. 2 is across sectional view taken along the lines 2-2 in FIG. 1.

FIG. 3 is an isometric, partially exploded view of the flexible packaging film appearing in FIG. 1, taken generally from the side intended to face the interior in a finished packaging article.

FIG. 4 is an isometric, partially exploded view of a second embodiment film construction, wherein the polymer layer has an alternative perforation pattern.

FIG. 5 is a flow chart illustrating an exemplary method for forming the packaging film of FIG. 1 or FIG. 4.

FIG. 6 is an isometric view of a finished packaging article formed of the film appearing in FIG. 1.

FIG. 7 is an isometric, fragmentary view of a flexible packaging film in accordance with a second exemplary embodiment of the invention, taken generally from the side intended to face the exterior in a finished packaging article.

FIG. 8 is across sectional view taken along the lines 8-8 in FIG. 7.

FIG. 9A is an isometric, partially exploded view of the flexible packaging film appearing in FIG. 7, taken generally from the side intended to face the interior in a finished packaging article.

FIG. 9B is an isometric, partially exploded view of the flexible packaging film, taken generally from the side intended to face the interior in a finished packaging article, which is similar to the packaging film appearing in FIGS. 7 and 9A, except that the adhesive layer is substantially continuously applied over the paper ply and/or polymer ply, except in the window region.

FIG. 10 is an isometric view of a second embodiment film construction, wherein the heat sealable polymer film layer has an alternative perforation configuration in the perforation region.

FIG. 11 is a flow chart illustrating an exemplary method for forming the packaging film of FIG. 7 or 10.

FIG. 12 is an isometric view of a finished packaging article formed of the film appearing in FIG. 7, 9B, or 10.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The term “ovenable” refers to packaging films that are able to withstand the high temperatures typically encountered in oven environments (e.g., in ovens which use radiant heating, convection heating, impingement heating, or microwave heating, or some combination thereof), without experiencing significant deterioration, such as burning, scorching, melting, deformation, discoloration, or other adverse effects. The ovenable packaging herein is advantageous for convenience foods or ready-to-eat meals that are intended to be heated or cooked directly in the packaging, which allows the contents to be cooked, heated, or warmed directly in some or all of its packaging, eliminating the need for transferring the food to another container, such as an oven-safe dish. This convenience allows for increased efficiency in quick service restaurants by reducing operational steps, while maintaining the quality and flavor of the food. It also provides convenience to consumers when heating or warming their food at home or on-the-go.

It will be recognized, however, that the products need not be foodstuffs and that the ovenable packaging structures may be used for a range of products, including industrial items, medical or therapeutic products, pharmaceuticals, and others, where consumers or users will want to heat in an oven or similar warming device.

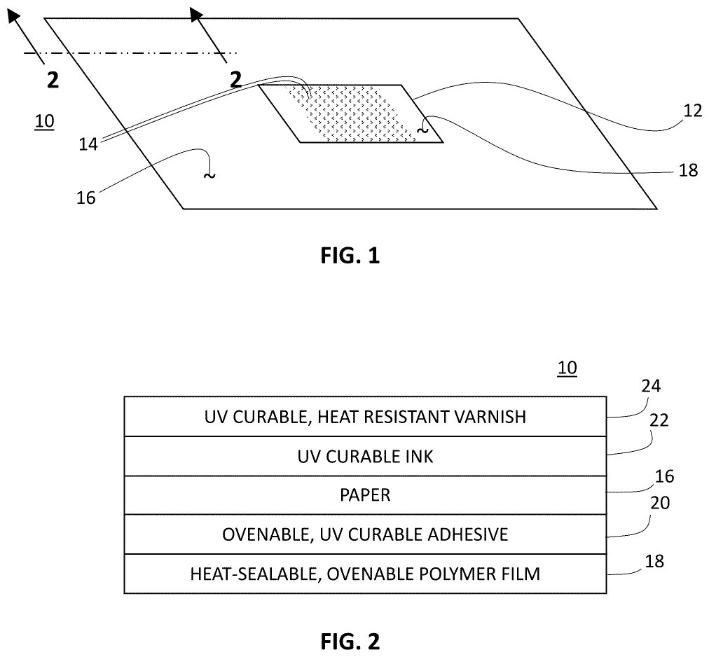

Referring now to the drawings, FIG. 1 illustrates a sheet material 10 comprising a window region 12 which contains a plurality of perforations 14 for venting during a heating or cooking process. The window size and size of the perforated area illustrated is exemplary only and can be customized, e.g., with respect to the perforated area, perforation density, perforation size, area and shape of the perforated regions/strips, etc., for controlling the evaporation of moisture from the product for better reheating quality. Although a generally rectangular window 12 is depicted, it will be recognized that the window 12 may be of any desired size or geometric shape. Also, in the depicted embodiment of FIG. 1, only a single strip of perforations is shown for ease of exposition, however, it will be recognized that other numbers of strips of perforations are contemplated.

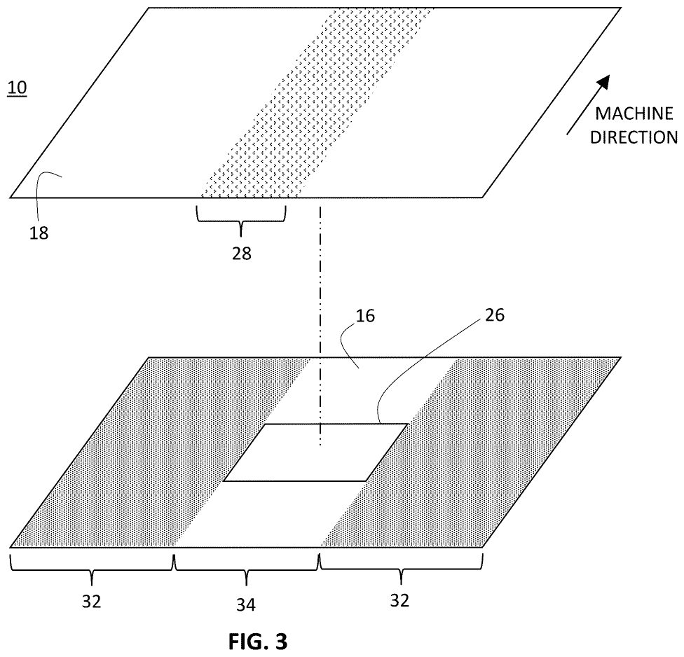

Referring now to FIG. 2, the material 10 includes a paper substrate layer 16 bonded to a heat-sealable polymer film layer 18 via a layer of adhesive 20. The outward facing surface is printed with a printed ink layer 22 for providing viewable indicia on the exterior of a finished packaging article 30 (see, e.g., FIG. 6). In embodiments a varnish over layer 24 is provided to protect the ink layer 22 from scuffing or rubbing off.

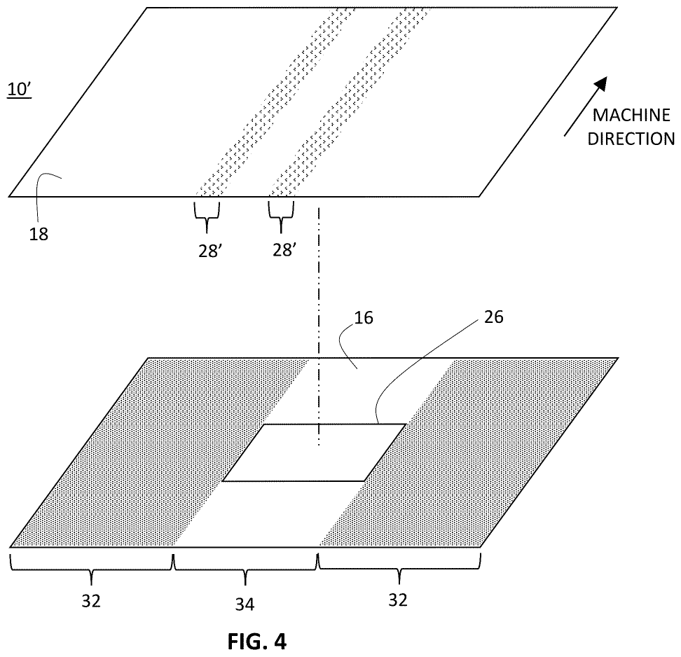

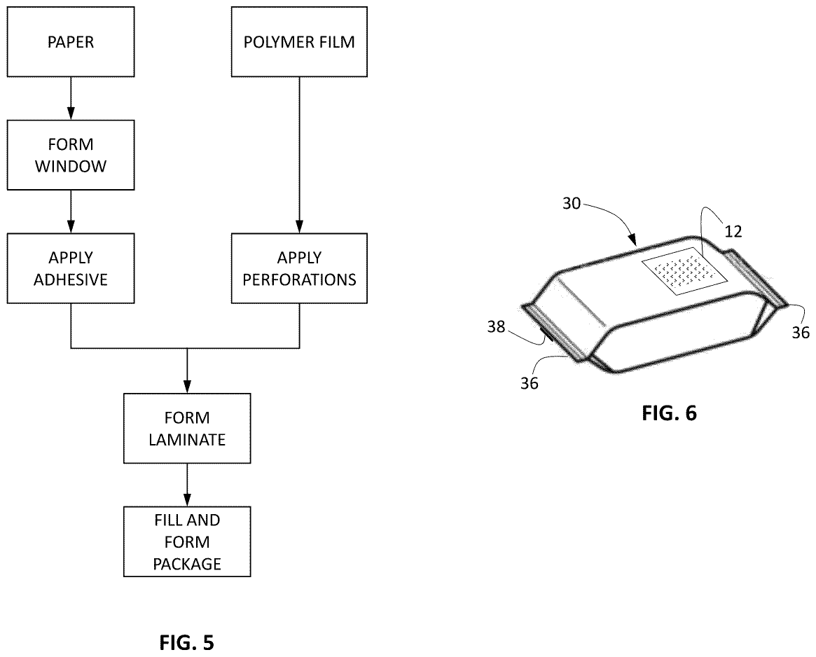

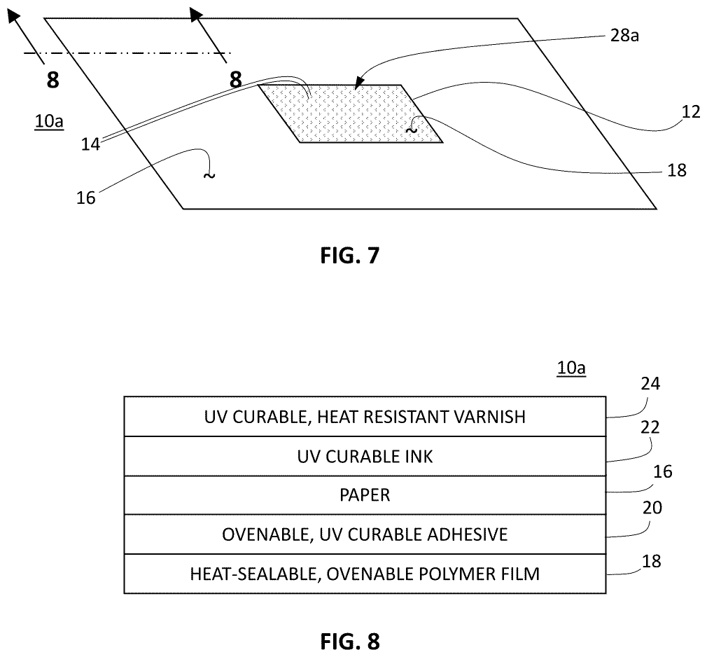

Referring now to FIG. 3, there appears an exploded view illustrating a window cutout 26 formed in the paper substrate 16 and a perforated strip 28 of perforations 14 formed in the polymer layer 18. The adhesive 20 is likewise applied in strips 32 with an adhesive-free region 34 therebetween so that the adhesive does not impinge on the perforations or come into contact with the contents of the packaging article 30. An alternative embodiment 10′ appears in FIG. 4 and is as described above except that it has two perforated regions or strips 28′.

In embodiments, the varnish over layer 24 is an ultraviolet (UV) curable, heat-resistant varnish. In embodiments, the ink 22 is a UV-curable ink. In embodiments, the ink and varnish layers are preprinted on the sheet or web 10 which can be stored on a roll for later processing. Alternatively, a printing station can be incorporated into the process line for printing at the same time the packaging article is formed. The printed ink layer 22 can be applied to the outer surface of the paper substrate 16 via any conventional printing method, as would be understood by persons skilled in the art, including without limitation, using a rotogravure printing apparatus, flexographic printing apparatus, offset printing apparatus, digital printing apparatus, ink jet printing apparatus, or the like.

In embodiments, the paper substrate layer 16 may be any suitable paper and is preferably a paper having a basis weight in the range of from about 35 gram per square meter (gsm) to about 130 gsm, e.g., 35 gsm, 40 gsm, 45 gsm, 50 gsm, 55 gsm, 60 gsm, 65 gsm, 70 gsm, 75 gsm, 80 gsm, 85 gsm, 90 gsm, 95 gsm, 100 gsm, 105 gsm, 110 gsm, 115 gsm, 120 gsm, 125 gsm, or 130 gsm, and more preferably about 70 gsm, and any subrange or subset thereof.

In embodiments, the paper substrate layer 16 is formed of a paper such as a natural kraft paper, a bleached kraft paper, a white kraft paper, coated papers, recycled papers, grease resistant papers, and so forth.

In embodiments, the paper substrate layer 16 is formed of a grease resistant paper. As used herein, the term “grease resistant paper” refers to a paper that exhibits sufficient resistance to grease or oil such that absorption or transmission of grease or oil is substantially reduced under normal use conditions. In embodiments, the grease-resistant paper layer 16 comprises a highly refined and calendared paper. In certain embodiments, the grease-resistant paper layer 16 comprises a coated paper having a grease resistant coating. In certain embodiments, the grease resistant coating comprises a bio-based coating such a starch based coating, sugar cane-based coating, or the like. The use of a grease resistant paper is particularly advantageous to address grease out issues for embodiments wherein the adhesive layer includes one or more adhesive free regions, such as the web 10 wherein adhesive is absent in the region 34. In certain embodiments, the paper substrate layer 16 comprises a bleached Kraft paper or a natural Kraft paper.

In embodiments, the adhesive 20 is an ovenable, UV curable adhesive. The adhesive 20 is applied intermediate the paper substrate layer 16 and the polymer film layer 18. In embodiments, the paper substrate layer 16 and the polymer film layer 18 are laminated by passing the layers between nip rollers. In embodiments, the UV adhesive has a dry or after curing coating weight in the range of from 2.5 gsm to 7.5 gsm, e.g., 2.5 gsm, 3 gsm, 3.5 gsm, 4 gsm, 4.5 gsm, 5 gsm, 5.5 gsm, 6 gsm, 6.5 gsm, 7 gsm, and 7.5 gsm, and more preferably about 5 gsm, and any subrange or subset thereof. In embodiments, the coating density of the UV adhesive is selected to provide low odor at elevated temperature while providing adequate bond strength.

The lower the adhesive coverage, the lower the odor and the lower the bond strength between the paper and polymer layers. A low bond strength resulting in easier separation of the paper and polymer layers may be advantageous for separating the layers, e.g., for recycling purposes. In embodiments, the adhesive is applied over 30%-100% of the area of the sheet material 10 excluding the perforated areas 28.

In embodiments, the lamination bond strength is in the range of from about 50 g/inch to about 500 g/inch. It has been found that fiber tear results at around 600-700 g/inch.

In embodiments, the flexible structure 10 has the following structure: UV heat-resistant varnish/UV ink/70 gsm paper/ovenable UV adhesive/heat-sealable, ovenable PET film.

In embodiments, the material 10 is configured to withstand oven temperatures in the range of 120 to 205 degrees Celsius (about 250-400 degrees F.) for a cook time in the range of 5-30 minutes.

In embodiments, the material 10 is configured to withstand an oven temperatures in the range of up to 260 degrees C. (500 degrees F.), e.g., 204-260 degrees C. (400-500 degrees F.) in so-called high speed or rapid cook ovens, such as are available from TurboChef Technologies, Inc. of Carrollton, TX and/or MerryChef, Inc. of Fort Wayne, IN, with a cook time in the range of from 15 seconds to 10 minutes.

In embodiments, the sheet materials herein are EU compliant, FDA compliant, or both. In embodiments, the sheet materials herein are compliant under the US FDA Conditions of Use for Food Contact Substances, condition H (frozen or refrigerated storage: ready-prepared foods intended to be reheated in container at time of use).

In embodiments, the polymer layer 18 is a polyethylene terephthalate (PET) material. In embodiments, the layer 18 is a heat sealable, ovenable PET material having a seal initiation temperature (SIT) in the range of from about 80° C. to about 160° C., e.g., 80° C., 85° C., 90° C., 95° C., 100° C., 105° C., 110° C., 115° C., 120° C., 125° C., 130° C., 135° C., 140° C., 145° C., 150° C., 155° C., or 160° C., and any subrange or subset thereof, and more preferably about 105° C., when sealed with a sealing pressure of 40 psi and a sealing dwell time of 0.5 seconds.

In embodiments, the seal strength of the polymer layer 18 when heat sealed to itself or another like layer is in the range of from about 200 g/inch to about 4000 g/inch, e.g., 200 g/inch, 300 g/inch, 400 g/inch, 500 g/inch, 600 g/inch, 700 g/inch, 800 g/inch, 900 g/inch, 1000 g/inch, 1100 g/inch, 1200 g/inch, 1300 g/inch, 1400 g/inch, 1500 g/inch, 1600 g/inch, 1700 g/inch, 1800 g/inch, 1900 g/inch, 2000 g/inch, 2100 g/inch, 2200 g/inch, 2300 g/inch, 2400 g/inch, 2500 g/inch, 2600 g/inch, 2700 g/inch, 2800 g/inch, 2900 g/inch, 3000 g/inch, 3100 g/inch, 3200 g/inch, 3300 g/inch, 3400 g/inch, 3500 g/inch, 3600 g/inch, 3700 g/inch, 3800 g/inch, 3900 g/inch, or 4000 g/inch, and any subrange or subset thereof, and is preferably about 500 g/inch. In embodiments, the polymer film 18 has a thickness in the range of from 12-30 microns, e.g., 12 microns, 13 microns, 14 microns, 15 microns, 16 microns, 17 microns, 18 microns, 19 microns, 20 microns, 21 microns, 22 microns, 23 microns, 24 microns, 25 microns, 26 microns, 27 microns, 28 microns, 29 microns, or 30 microns, and any subrange of subset thereof.

FIG. 5 illustrates an exemplary process for forming the laminated structure 10. In embodiments, a paper web is unwound from a roll and a window is formed, e.g., by die cutting. A UV curable adhesive is applied, e.g., via roll coating to form the strips of adhesive. A polymer web is unwound from a roll and one or more strips of perforations are formed, e.g., using a needle perforation roller. To form the laminate, the paper and polymer webs are brought together, e.g., by feeding them into the nip of a pair of nip rollers and UV radiation is applied to cure the adhesive. The laminate may be wound up onto a take up roll for later use or may be fed to a packaging station such as a flow wrap machine to fill and form the package. In embodiments, the paper and polymer webs may have a breadth that allows forming multiple films side by side which may then be slit to form separate rolls.

FIG. 6 illustrates a packaging article 30. In the illustrated embodiment, the packaging article 30 is a flow wrap type bag having transverse end seals 36 and a longitudinally extending fin seal 38 on the lower or rear surface. It will be recognized that the film structures 10, 10′ herein may be used to form other packaging articles, including without limitation, pillow bags, stand up pouches with or without side gussets, quad seal pouches, and others.

Referring now to FIGS. 7-12, and specifically FIGS. 7-9, there is shown a sheet material 10a comprising a paper ply 16 laminated to an ovenable heat sealable polymer film ply 18. The paper ply includes a cutout 26 defining or bounding a window region 12. The ovenable heat sealable polymer film ply 18 includes a discrete perforation region 28′ which contains a plurality of perforations 14 for venting during a heating or cooking process. The perforated region 28′ is positioned in registration with the window region 12.

As used herein, the terms “registered” or “in registration with” mean that one feature or region is positionally aligned with a corresponding feature in both the machine and transverse directions, even if the features are on different plies or surfaces of the laminate. The terms “registered” and “in registration with” are intended to encompass substantial alignment, allowing for minor misalignment within normal manufacturing tolerances.

The size of the window region 12 and the size of the perforation region 28′ as illustrated are exemplary only and can be customized, e.g., with respect to the size, shape, perforated area, perforation density, perforation size, and shape of the perforated region(s), etc., for controlling the evaporation of moisture from the product for better reheating quality. Although a generally rectangular window 12 is depicted, it will be recognized that the window 12 may be of any desired size or geometric shape.

Any conventional web-registration technique may be used to align the plies 16, 18, including mechanical web guides, tension-control systems, and optical or sensor-based edge or mark detectors. Registration may also be maintained using synchronized draw rollers or pin-and-hole systems as would be understood by persons skilled in the art.

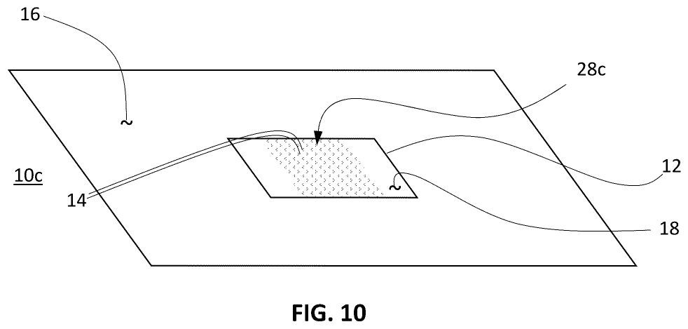

For purposes of illustration, FIGS. 7-9 depict only a segment of the sheet 10a, and FIG. 10 depicts only a segment of the sheet 10b, corresponding to the material required for forming a single packaged article, such as a packaging article 30a (see FIG. 12). It will be understood, however, that these depictions are provided solely for ease of exposition. In practice, the sheets 10a, 10b, 10c are configured as continuous webs having a repeating pattern of such segments along its length, and the webs may be stored on rolls prior to conversion. For example, in typical packaging operation, such as in a horizontal flow-wrap process or vertical form-fill-seal process, the continuous web is formed into a tube by bringing the lateral edges together to create a longitudinal fin seal 38 (see FIG. 12), after which successive transverse seals are formed to define individual packages. The web is then cut at the transverse seals to separate the packages. Accordingly, although FIGS. 7, 9A, 9B, and 10 show only one unit-length segments of the webs 10a, 10b, 10c it will be recognized that the webs extends continuously beyond the illustrated portion for processing in a conventional packaging line.

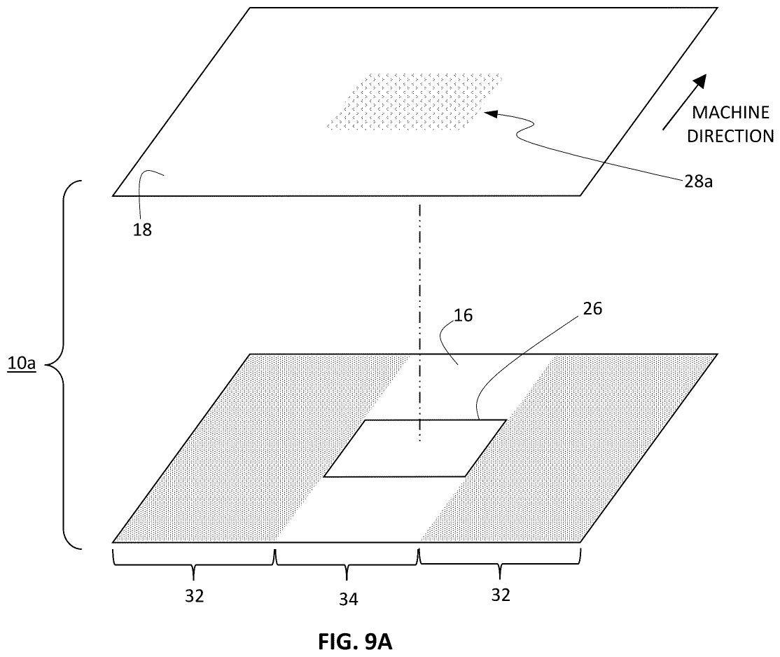

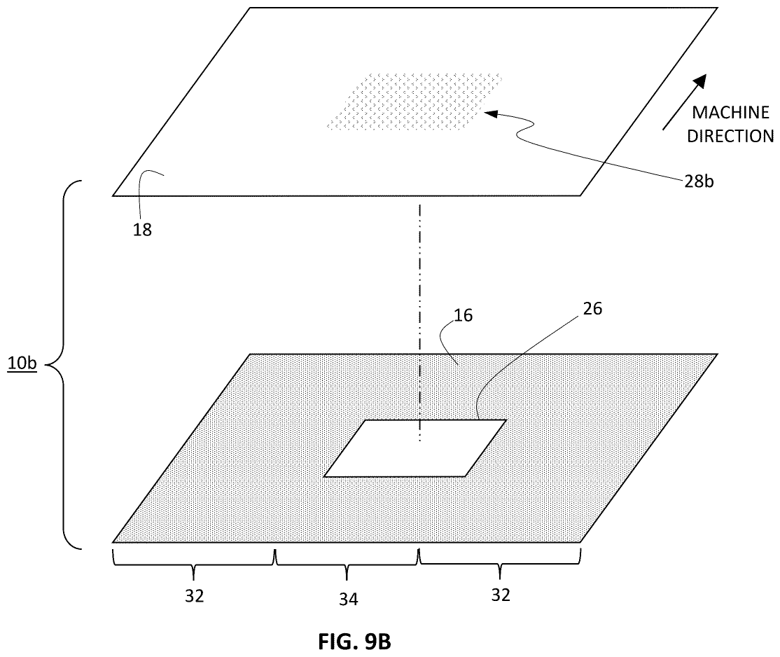

As shown, the perforated region 28a and 28b of FIGS. 9A and 9B, respectively, are substantially coextensive with the corresponding window region 12 defined by the cutout 26 of the respective ply 16. In the embodiment of FIG. 10, the sheet 10b may be as otherwise described herein with respect to the sheet 10a or 10b, except that the perforated region 28c covers only a portion of the area defined by the window region 12, thereby providing only partial perforation coverage. It will be recognized that other configurations of the perforated region may be used. The number, size, and arrangement of perforations 14 within the perforation regions 28a, 28b, and 28c may be varied or selected to obtain a packaging article exhibiting particular ovening characteristics, e.g., which may depend on the product to be packaged and heated.

As best seen in FIG. 8, the material 10a includes a paper substrate layer 16 bonded to a heat-sealable polymer film layer 18 via a layer of adhesive 20. In embodiments,. the outward facing surface may be printed with a printed ink layer 22 for providing viewable indicia on the exterior of a finished packaging article 30a (see, e.g., FIG. 12). In embodiments, a varnish layer 24 is applied over the ink layer 22 to protect the ink layer 22 from scuffing or rubbing off.

Referring now to FIG. 9A, there appears an exploded view of the web 10a illustrating a window cutout 26 formed in the paper substrate 16 and a perforation region 28a of perforations 14 formed in the heat sealable polymer layer 18. The adhesive 20 is likewise applied in strips 32 with an adhesive-free region 34 therebetween so that the adhesive does not impinge on the perforations or come into contact with the contents of the packaging article 30a.

In certain embodiments, it has been observed that the presence of a varnish layer on the outwardly facing surface of the paper ply 16 may inhibit or otherwise adversely affect bonding of the laminating adhesive 20 between the plies 16 and 18, depending upon the respective compositions of the adhesive layer 20 and the varnish layer 24. Accordingly, in some embodiments, the varnish layer 24 may be omitted from those portions of ply 16 that correspond to the adhesive regions 32, and may instead be applied only to the non-adhesive region 34 (exclusive of the window region 12). In this manner, the varnish layer 24 may be provided where protection of the underlying ink layer is desired, while maintaining reliable laminate bonding in the adhesive regions.

In certain embodiments, the adhesive regions 32 and the non-adhesive regions 34 are provided as elongate strips extending in the machine direction of the web (see FIG. 9A). The non-adhesive region 34 may be disposed as a central strip, with the adhesive regions 32 being positioned on opposing lateral sides thereof. During a flow-wrap packaging process in which the web is folded to form packages, the non-adhesive region 34 becomes aligned with and extends along the center of the front panel of the finished pack, which is typically the location where protection of the printed imagery is most desirable. This selective placement of the varnish layer may allow the varnish layer to provide protection to the ink layer 22 in the visually prominent front-panel portion of the package 30a, while maintaining suitable adhesive bonding in regions 32 during lamination.

In certain embodiments, the varnish layer 24 may comprise a grease resistant varnish formulation. As used herein, the term “grease resistant” refers to the ability of the varnish layer to inhibit or substantially prevent the transmission or migration of oils or grease through the ply 16 in those portions where the varnish layer is applied. As noted above, in certain embodiments, the varnish layer is applied to the region 34 where the laminating adhesive is absent. As noted above, in certain embodiments the non-adhesive region 34 may become aligned with the front-panel portion of the finished package, and in such configurations the grease-resistant varnish layer may provide a protective barrier against grease out or staining in this visually prominent area. In this manner, the selective application of a grease-resistant varnish layer to the region 34 may supplement or replace the grease barrier contribution that might otherwise be provided by the laminating adhesive 20 if it were present, while still permitting reliable adhesive bonding in the regions 32 where the varnish layer is omitted. In such embodiments, the adhesive layer 20 present in the regions 32 may itself contribute to grease barrier performance in the regions 32, such that the omission of the varnish layer in the adhesive regions 32 does not materially diminish the overall grease resistant properties of the structure 10a.

Referring now to FIG. 9B, there appears an exploded view of an alternative web embodiment 10b illustrating a window cutout 26 formed in the paper substrate 16 and a perforation region 28b containing perforations 14 formed in the heat sealable polymer layer 18. The web embodiment 10b appearing in FIG. 9B is as described herein by way of reference to the web 10a appearing in FIG. 9A, except that the laminating adhesive 20 is substantially contiguous with the paper ply 16. It will be recognized that the adhesive material does not extend into the window region 12.

It will be recognized that the laminating adhesive may be applied onto either or both of the facing surfaces of the paper web ply 16 and polymer web ply 18 in a substantially continuous manner, provided however, that no adhesive is applied or remains in the window region 12 of the laminated structure 10b. The adhesive layer is advantageously applied to the paper web 16. For example, in embodiments, the adhesive material may be continuously applied to the ply 16 after the cutout 26 is formed, such that the ply 16 lacks a substrate surface within the window region 12 to receive the adhesive. Alternatively, the adhesive material may be continuously applied to the ply 16 before the cutout 26 is formed, such that the portion of the ply 16 within the window region 12 is removed by the cutting step forming the window 26, such that the window region 12 in the resulting laminate 10b is devoid of adhesive. In either case, the resulting window region 12 is devoid of adhesive, thus ensuring that the perforations 14 in the perforated region 28b remain in an open or unoccluded state.

By applying the adhesive 20 around the periphery of the cutout 26, as shown in the web structure 10b, a more effective seal is formed around the cutout 26.

An alternative embodiment web 10c appears in FIG. 10 and is as described above by way of reference to the webs 10a or 10b, except that the perforation region 28c only partially occupies the window region 12.

In embodiments, the varnish layer 24 is an ultraviolet (UV) curable, heat-resistant varnish. In embodiments, the ink 22 is a UV-curable ink. In embodiments, the ink and varnish layers are preprinted on the sheet or web 10 which can be stored on a roll for later processing. Alternatively, a printing station can be incorporated into the process line for printing at the same time the packing article is formed. The printed ink layer 22 can be applied to the outer surface of the paper substrate 16 via any conventional printing method as would be understood by persons skilled in the art, including without limitation, using a rotogravure printing apparatus, flexographic printing apparatus, offset printing apparatus, digital printing apparatus, ink jet printing apparatus, or the like.

In embodiments, the paper substrate layer 16 may be any suitable paper and is preferably a paper having a basis weight in the range of from about 35 gram per square meter (gsm) to about 130 gsm, e.g., 35 gsm, 40 gsm, 45 gsm, 50 gsm, 55 gsm, 60 gsm, 65 gsm, 70 gsm, 75 gsm, 80 gsm, 85 gsm, 90 gsm, 95 gsm, 100 gsm, 105 gsm, 110 gsm, 115 gsm, 120 gsm, 125 gsm, or 130 gsm, and more preferably about 70 gsm, and any subrange or subset thereof.

In embodiments, the adhesive 20 is an ovenable, UV curable adhesive. The adhesive 20 is applied intermediate the paper substrate layer 16 and the polymer film layer 18. In certain embodiments, the paper substrate layer 16 and the polymer film layer 18 are laminated by passing the layers between the nip of laminating rollers. In embodiments, the UV adhesive has a dry or after curing coating weight in the range of from 2.5 gsm to 7.5 gsm, e.g., 2.5 gsm, 3 gsm, 3.5 gsm, 4 gsm, 4.5 gsm, 5 gsm, 5.5 gsm, 6 gsm, 6.5 gsm, 7 gsm, and 7.5 gsm, and more preferably about 5 gsm, and any subrange or subset thereof. In embodiments, the coating density of the UV adhesive is selected to provide low odor at elevated temperature while providing adequate bond strength.

The lower the adhesive coverage, the lower the odor and the lower the bond strength between the paper and polymer layers. A low bond strength resulting in easier separation of the paper and polymer layers may be advantageous for separating the layers, e.g., for recycling purposes. In embodiments, the adhesive is applied over 30%-100% of the area of the sheet material 10, excluding the perforated areas 28a, 28b, 28c.

In embodiments, the lamination bond strength is in the range of from about 50 g/inch to about 500 g/inch. It has been found that fiber tear results at around 600-700 g/inch.

In embodiments, the flexible structure 10 has the following structure: UV heat-resistant varnish/UV ink/70 gsm paper/ovenable UV adhesive/heat-sealable, ovenable polymer film.

In embodiments, the material 10 is configured to withstand oven temperatures in the range of 120 to 205 degrees Celsius (about 250-400 degrees F.) for a cook time in the range of 5-30 minutes.

In embodiments, the material 10 is configured to withstand an oven temperatures in the range of up to 260 degrees C. (500 degrees F.), e.g., 204-260 degrees C. (400-500 degrees F.) in so-called high speed or rapid cook ovens, such as are available from TurboChef Technologies, Inc., of Carrollton, TX and/or MerryChef, Inc., of Fort Wayne, IN, with a cook time in the range of from 15 seconds to 10 minutes.

In embodiments, the sheet materials herein are EU compliant, FDA compliant, or both. In embodiments, the sheet materials herein are compliant under the US FDA Conditions of Use for Food Contact Substances, condition H (frozen or refrigerated storage: ready-prepared foods intended to be reheated in container at time of use).

In embodiments, the heat sealable polymer layer 18 is formed of a suitable polymer material such as heat sealable polyolefin-based polymer materials, heat sealable polyamide-based polymer materials, heat sealable polyester-based polymer materials, and heat sealable regenerated cellulose-based, e.g., cellophane, polymer materials.

In embodiments, the ovenable heat-sealable polymer layer 18 is formed of a suitable polyolefin-based polymer material. In embodiments, the ovenable heat-sealable polymer layer 18 is formed of a polyolefin-based polymer material formulated to provide a sealing initiation temperature (SIT) in the range of about 80° C. to about 160° C., e.g., 80° C., 85° C., 90° C., 95° C., 100° C., 105° C., 110° C., 115° C., 120° C., 125° C., 130° C., 135° C., 140° C., 145° C., 150° C., 155° C., or 160° C. and any subrange or subset thereof, and more preferably about 105° C., when sealed with a sealing pressure of 40 psi and a sealing dwell time of 0.5 seconds.

In embodiments, the ovenable heat-sealable polymer layer 18 is formed of a polyethylene-based polymer materials selected from low-density polyethylene (LDPE), linear low-density polyethylene (LLDPE), and metallocene polyethylene (mPE). In embodiments, the ovenable heat-sealable polymer layer 18 is formed of a polypropylene-based polymer material. In embodiments, the ovenable heat-sealable polymer layer 18 is formed of cast polypropylene (CPP). In embodiments, the ovenable heat-sealable polymer layer 18 comprises a copolymer of polyethylene and polypropylene. In embodiments, the ovenable heat-sealable polymer layer 18 comprises a copolymer derived from ethylene, propylene, or a combination thereof, optionally with other comonomers. In embodiments, the ovenable heat-sealable polymer layer 18 is formed of a blend of a polyethylene-based polymer and polypropylene-based polymer.

In embodiments, the polymer layer 18 is formed of a suitable polyester-based polymer material. In embodiments, the polymer layer 18 is formed of a suitable polyester-based polymer material having a seal initiation temperature (SIT) in the range of about 80° C. to about 160° C., e.g., 80° C., 85° C., 90° C., 95° C., 100° C., 105° C., 110° C., 115° C., 120° C., 125° C., 130° C., 135° C., 140° C., 145° C., 150° C., 155° C., or 160° C., and any subrange or subset thereof, and more preferably about 105° C., when sealed with a sealing pressure of 40 psi and a sealing dwell time of 0.5 seconds.

In embodiments, the polymer layer 18 is formed of a suitable polyester-based polymer material selected from polyethylene terephthalate (PET), polybutylene terephthalate (PBT), and blends of PET and PBT. In embodiments, the polymer layer 18 is formed of a biaxially oriented polyethylene terephthalate (BOPET).

In embodiments, the ovenable heat-sealable polymer layer 18 is formed of a suitable polyamide-based polymer material. In embodiments, the ovenable heat-sealable polymer layer 18 is formed of a polyamide-based polymer material formulated to provide a sealing initiation temperature (SIT) in the range of about 80° C. to about 160° C., e.g., 80° C., 85° C., 90° C., 95° C., 100° C., 105° C., 110° C., 115° C., 120° C., 125° C., 130° C., 135° C., 140° C., 145° C., 150° C., 155° C., or 160° C. and any subrange or subset thereof, and more preferably about 105° C., when sealed with a sealing pressure of 40 psi and a sealing dwell time of 0.5 seconds. In embodiments, the ovenable heat-sealable polymer layer 18 is formed of nylon 6, nylon 6,6, or a polyamide copolymer or blend.

In embodiments, the ovenable heat-sealable polymer layer 18 is formed of a suitable heat sealable regenerated cellulose film, such as a cellophane or a modified cellophane film. In certain embodiments, the heat sealable regenerated cellulose film/cellophane film comprises cellulose modified with one or more heat seal promoting additives, such as partially saponified polyvinyl acetate, polyvinyl alcohol, glycerol, plasticizers, and the like.

In embodiments, the seal strength of the heat-sealable polymer layer 18 when heat sealed to itself or another like layer is in the range of from about 200 g/inch to about 4000 g/inch, e.g., 200 g/inch, 300 g/inch, 400 g/inch, 500 g/inch, 600 g/inch, 700 g/inch, 800 g/inch, 900 g/inch, 1000 g/inch, 1100 g/inch, 1200 g/inch, 1300 g/inch, 1400 g/inch, 1500 g/inch, 1600 g/inch, 1700 g/inch, 1800 g/inch, 1900 g/inch, 2000 g/inch, 2100 g/inch, 2200 g/inch, 2300 g/inch, 2400 g/inch, 2500 g/inch, 2600 g/inch, 2700 g/inch, 2800 g/inch, 2900 g/inch, 3000 g/inch, 3100 g/inch, 3200 g/inch, 3300 g/inch, 3400 g/inch, 3500 g/inch, 3600 g/inch, 3700 g/inch, 3800 g/inch, 3900 g/inch, or 4000 g/inch, and any subrange or subset thereof, and is preferably about 500 g/inch.

In embodiments, the polymer film 18 has a thickness in the range of from about 12 microns to about 30 microns, e.g., 12 microns, 13 microns, 14 microns, 15 microns, 16 microns, 17 microns, 18 microns, 19 microns, 20 microns, 21 microns, 22 microns, 23 microns, 24 microns, 25 microns, 26 microns, 27 microns, 28 microns, 29 microns, or 30 microns, and any subrange or subset thereof.

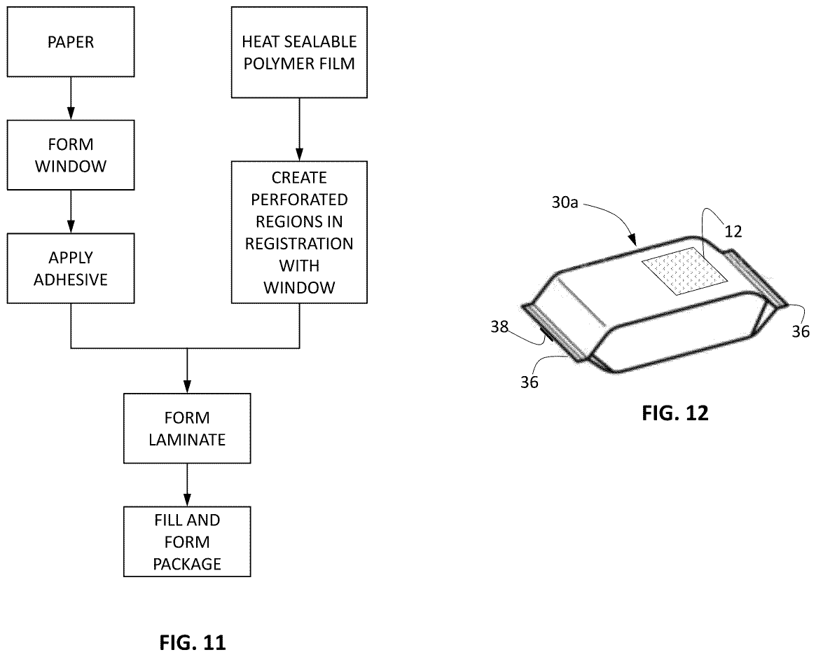

FIG. 11 illustrates an exemplary process for forming the laminated structures 10a, 10b, or 10c. In embodiments, a paper web is unwound from a roll and a cutout 26 defining a window 12 is formed, e.g., by advancing the web 16 past a cutting station, such as a die cutting station.

Further like window regions 12 are formed in the web 16, which are spaced at predetermined intervals corresponding to the machine-direction dimension of packages to be formed from the web. The spacing between windows 12 may be achieved by synchronization of the motion of the web 16 so that the windows 12 are spaced apart at the desired intervals along the web 16.

An adhesive such as a UV curable adhesive is applied to the inward surface of the paper ply 16, e.g., via roll coating. In the case of the web structure 10a or 10c, strips of adhesive extending in the machine direction are applied to the inward facing surface of the paper ply 16 in the adhesive strip regions 32 on opposing transverse sides of the non-adhesive region 34. In the case of the web structure 10b, the adhesive is applied over substantially the entire inward facing surface of the paper ply 16, including in the central region 34.

A web comprising a polymer film is unwound from a roll and a discrete perforation region 28a, 28b, or 28c comprising a plurality of perforation 14 is formed is formed by advancing the web 18 past a perforation station. At the perforation station, a patterned die, laser, or rotary punch, or the like may be used to create an array of perforations 14 within the perforation region 28a, 28b, or 28c of the polymer web 18. The size, number, and arrangement of the perforations 14 can be selected in accordance with a desired venting characteristic of the packs to be produced as well as the cooking characteristics of the products to be packaged.

Further like perforation regions 28a, 28b, or 28c are formed in the web 18, which are spaced at the same predetermined intervals corresponding to the machine-direction dimension of the packages to be formed from the web, wherein the spacing may be achieved by synchronizing the motion of the web 18 so that the perforation regions 28a, 28b, or 28c are spaced apart at the desired intervals along the web 18.

In certain embodiments, the windows 12 and perforation regions 28a, 28b, or 28c may be formed on the webs 16 and 18, respectively, immediately prior to a lamination step in an in-line process. Alternatively, the windows 12 and perforation regions 28a, 28b, or 28c may be formed on the webs 16 and 18, respectively, separately wherein the webs 16, 18 are wound onto rolls for storage. The pre-formed webs may subsequently be unwound and brought together for lamination, such that the previously formed windows 12 and perforation regions 28a, 28b, or 28c are aligned. In this manner, the windows 12 and perforation regions 28a, 28b, or 28c can be formed either in situ during lamination or in advance on the individual webs 16, 18, thereby providing flexibility in manufacturing.

Regardless of whether the windows 12 and perforation regions 28a, 28b, or 28c are formed in situ during the lamination process or preformed on the individual webs 16 and 18, respectively, the adhesive is applied as described above and the webs 16 and 18 are subsequently brought together and laminated to form the desired laminated structure, e.g., by feeding the webs 16, 18 into the nip of lamination rollers. In certain embodiments, the adhesive is a UV-curable adhesive, wherein UV radiation is applied during the lamination step to cure the adhesive.

The laminate may be wound up onto a take up roll for later use or may be fed to a packaging station such as a flow wrap machine to fill and form the package. In embodiments, the paper and polymer webs 16, 18, respectively, may have a breadth that allows forming multiple films side by side which may then be slit to form separate rolls.

Although in the illustrated example appearing in FIG. 11 the adhesive is applied to the outer paper web 16, other embodiments are contemplated wherein the adhesive is be applied to the polymer web 18 or to both the paper web 16 and the polymer web 18, provided however, that the adhesive does not impinge upon the perforations 14 within the perforation region 28

FIG. 12 illustrates a packaging article 30a. In the illustrated embodiment, the packaging article is a flow wrap type bag having transverse end seals 36 and a longitudinally extending fin seal 38 on the lower or rear surface. It will be recognized that the film structures 10a, 10b, and 10c herein may be used to form other packaging articles, including without limitation, pillow bags, stand up pouches with or without side gussets, quad seal pouches, and others.

The terms “a” or “an,” as used herein, are defined as one or more than one. The term “another,” as used herein, is defined as at least a second or more. The terms “including” and/or “having” as used herein, are defined as comprising (i.e., open transition). The term “attached,” “coupled,” or “operatively coupled,” as used herein, is defined as indirectly or directly connected.

As used in this application, the terms “front,” “rear,” “upper,” “lower,” “upwardly,” “downwardly,” “left,” “right,” and other orientation descriptors are intended to facilitate the description of the exemplary embodiment(s) of the present invention, and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

1. A laminated web of material having a machine direction and a transverse direction which extends in a direction perpendicular to the machine direction, the laminated web comprising:
an outer ply comprising a paper material having a cutout defining a window region disposed at a predetermined location on the outer ply;
an inner ply comprising a heat sealable, ovenable polymer film having a perforation region wherein the perforation region is disposed at a predetermined location on the inner ply; and
an adhesive layer disposed intermediate the outer ply and the inner ply, the adhesive layer bonding the outer ply to the inner ply;
wherein, in the laminated web, the outer ply and the inner ply are in registration with each other such that the perforation region is substantially overlapping with the window region.

2. The laminated web of claim 1, wherein the perforation region defines a discrete region that does not form a continuous strip in the machine direction.

3. The laminated web of claim 1, wherein the perforation region is bounded entirely within the window region.

4. The laminated web of claim 1, further comprising one of:
the perforation region and the window region are substantially coextensive; and
the perforation region is smaller in area than the window region.

5. The laminated web of claim 1, further comprising one or both of:
the adhesive layer is defined by first and second adhesive strips extending in the machine direction, wherein the first and second adhesive strips are disposed on opposing transverse sides of the window region; and
the adhesive layer comprises one or more adhesive free regions wherein adhesive is absent from the adhesive layer, the one or more adhesive free regions being disposed upstream of the window region in the machine direction, downstream of the window region in the machine direction, or both.

6. (canceled)

7. The laminated web of claim 5, further comprising:
a varnish layer disposed on an outward facing surface of the outer ply.

8. The laminated web of claim 7, wherein the varnish layer is in registration with the one or more adhesive free regions.

9. The laminated web of claim 5, wherein the adhesive layer comprises:
a first adhesive free region wherein adhesive is absent from the adhesive layer, the first adhesive free region being disposed upstream of the window region in the machine direction; and
a second adhesive free region wherein adhesive is absent from the adhesive layer, the second adhesive free region being disposed downstream of the window region in the machine direction.

10. The laminated web of claim 1, wherein the adhesive layer forms a substantially continuous layer surrounding the window region, and wherein the window region is substantially free of adhesive.

11. The laminated web of claim 1, further comprising:
a varnish layer disposed on an outward facing surface of the outer ply; optionally wherein the varnish layer comprises an ultraviolet (UV) curable, heat-resistant varnish.

12. The laminated web of claim 11, further comprising:
a printed ink layer disposed between the varnish layer and the outward facing surface of the outer ply, optionally wherein the printed ink layer comprises an ultraviolet (UV) curable ink.

13. (canceled)

14. (canceled)

15. The laminated web of claim 1, wherein the outer ply comprises a paper material selected from the group consisting of a natural kraft paper, a bleached kraft paper, a white kraft paper, a coated paper, a recycled paper, a grease resistant paper, and a paper having a basis weight in the range of from about 35 grams per square meter (gsm) to about 130 gsm.

16. (canceled)

17. The laminated web of claim 1, wherein the inner ply comprises one or both of:
a polymer material configured to provide a sealing initiation temperature (SIT) in the range of from about 80° C. to about 160° C. when sealed under a sealing pressure of 40 psi for a dwell time of 0.5 seconds; and
an ovenable polymer film is configured to provide a seal strength in the range of from 200 g/inch to 4000 g/inch.

18. The laminated web of claim 1, wherein the inner ply comprises a polymer material selected from the group consisting of a heat sealable polyolefin-based polymer material, a heat sealable polyamide-based polymer material, a heat sealable polyester-based polymer material, and a heat sealable regenerated cellulose-based polymer material.

19. The laminated web of claim 18, wherein the polymer material is selected from the group consisting of low-density polyethylene (LDPE), linear low-density polyethylene (LLDPE), metallocene polyethylene (mPE), cast polypropylene (CPP), copolymers derived from ethylene and propylene, copolymers derived from ethylene, propylene, and one or more additional comonomers, polyethylene-polypropylene blends, polyethylene terephthalate (PET), polybutylene terephthalate (PBT), blends of PET and PBT, biaxially oriented polyethylene terephthalate (BOPET), nylon 6, nylon 6,6, polyamide copolymers, polyamide blends, regenerated cellulose, cellophane, and regenerated cellulose modified with one or more heat seal promoting additives.

20. (canceled)

21. The laminated web of claim 1, wherein the heat sealable polymer layer has a thickness in the range of from about 12 microns to about 30 microns.

22. A packaging article formed of the laminated web of claim 1, optionally wherein the packaging article is selected from the group consisting of a bag and a pouch.

23. (canceled)

24. A method of making a laminated web, comprising:
providing an outer ply comprising a paper substrate, the outer ply having a first major surface and a second major surface opposite the first major surface;
forming a cutout defining a window in the outer ply;
providing an inner ply comprising a heat sealable polymer film, the inner ply having a first major surface facing the second major surface of the outer ply, the inner ply having a second major surface opposite the first major surface of the inner ply;
forming a perforation region comprising a plurality of perforations bounded within the perforation region on the inner ply;
applying an adhesive to one or both of the second major surface of the outer ply and the first major surface of the inner ply; and
forming a laminate by bringing the outer ply and the inner ply into contact, wherein, in the laminated web, the outer ply and the inner ply are in registration with each other such that the perforation region is substantially overlapping with the window region.

25. The method of claim 24, further comprising one or both of:
forming a printed ink layer disposed on at least a portion of the first major surface of the outer ply; and
forming a varnish layer disposed on at least a portion of the first major surface of the outer ply.

26. The method of claim 24, further comprising folding, sealing, and/or manipulating the laminated web to thereby form a packaging article.
